(19) United States
(12) Patent Application Publication
(10) Pub. No.: US 2006/0238616 A1
(43) Pub. Date: Oct. 26, 2006

(54) VIDEO IMAGE PROCESSING APPLIANCE MANAGER

(75) Inventors: Keith L. Curtner, St. Paul, MN (US); Saad J. Bedros, West St. Paul, MN (US); KwongWing Au, Bloomington, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 10/907,410

(22) Filed: Mar. 31, 2005

(51) Int. Cl. H04N 9/47; H04N 7/16; G06F 15/173; H04N 7/18; H04N 7/173; H04H 9/00

(52) U.S. Cl. 348/143; 709/223; 725/105; 725/10; 725/12; 348/142

(57) ABSTRACT

A video monitoring system including a video image-processing appliance manager adapted to provide an interface for one or more monitoring devices is disclosed. A video monitoring system in accordance with an illustrative embodiment of the present invention may include a host application including one or more monitoring devices, a video image-processing appliance manager called by the host application, and one or more appliance modules called by the appliance manager and adapted to run a number of video image-processing algorithms or routines that can be used to detect the occurrence of events within a region of interest. Methods of interfacing with one or more monitoring devices within a video monitoring network are also disclosed herein.

### FIELD

The present invention relates generally to the field of video image processing. More specifically, the present invention pertains to devices and methods for interfacing with one or more monitoring devices within a video monitoring system.

### BACKGROUND

Video monitoring systems are used in a variety of applications for monitoring objects within an environment. In security applications, for example, such systems are sometimes employed to track individuals or vehicles entering or leaving a building facility or security gate, or to monitor individuals within a store, office building, hospital, or other such setting where the health and/or safety of the occupants may be of concern. In the aviation industry, for example, such systems have been used to monitor the presence of individuals at key locations within an airport such as at a security gate or parking garage.

In certain systems, video image-processing modules may be employed to process video images that can be used to detect the occurrence of events within a region of interest. Such video image-processing modules are typically stand-alone modules that are hard-coded to run a number of algorithms or routines based on their intended use. In certain designs, for example, such modules may be provided as part of a network server software program that interacts with one or more monitoring devices (e.g. digital video monitors) based on a number of pre-programmed rules or constructs. A graphical user interface may be provided in certain systems to permit the user to interact with the software program in order to task the video monitoring system in a particular manner.

While many video image-processing modules provide a means to change settings relating to the implementation of algorithms already programmed therein, such devices typically lack the ability to easily add algorithmic functionality or analysis functions without having to re-code the entire software program. In some cases, the addition of new clients may require the user to re-formulate the entire software program to accommodate the additional clients. Such requirements may increase the complexity of the system, and may prevent future expansion of the system as new components are added to the existing system.

### SUMMARY

The present invention pertains to devices and methods for interfacing with one or more monitoring devices within a video monitoring system. A video monitoring system in accordance with an illustrative embodiment of the present invention may include a host application including one or more monitoring devices, a video image-processing appliance manager called by the host application, and one or more appliance modules called by the appliance manager and adapted to run a number of video image-processing algorithms or routines. The appliance manager can be configured to run an initiation algorithm for acquiring information about the type of monitoring devices employed by the system, the type of appliance modules to be tasked, as well as other parameters. Once initialized, the appliance manager can then be configured to run a video analysis algorithm that analyzes images acquired from the monitoring devices in order to detect the occurrence of one or more events contained within an event database. Once a configured event is detected, or at some other desired time established by the user, the appliance manager can be configured to close the video analysis algorithm and output a response notifying the user of the occurrence of the event.

The appliance manager can be configured to permit the modular incorporation of future appliance modules within the video monitoring system without having to re-code the host application software program. In certain embodiments, the video monitoring system may include a video motion detection module, a video motion tracking module, an object classification module, an event detection module, and an action dispatcher module. Other appliance modules can be added to the system to perform other tasks, as desired. In certain embodiments, the appliance manager can include a manager harness to permit the user to send various parameters to the appliance manager for evaluating or testing new or existing appliance modules, and/or for processing previously recorded video streams to detect the occurrence an event.

An illustrative method of interfacing with one or more monitoring devices within a video monitoring network may include the steps of providing a video image-processing appliance manager in communication with a host application including one or more monitoring devices, associating the appliance manager with one or more appliance modules each adapted to run a number of video image-processing algorithms or routines, analyzing video images received from at least one of the monitoring devices using one or more of the appliance modules, and then outputting a response to the host application and/or a user.

### BRIEF DESCRIPTION OF THE DRAWINGS

FIG. 1 is a block diagram showing an illustrative network-based video monitoring system for use in monitoring one or more regions of interest within an environment;

FIG. 2 is a block diagram showing the architecture of a video image-processing appliance manager in accordance with an exemplary embodiment of the present invention;

FIG. 3 is a flow chart showing an illustrative video image-processing algorithm for use by the appliance manager of FIG. 2;

FIG. 4 is a flow chart showing an illustrative initialization algorithm in accordance with an exemplary embodiment of the present invention;

FIG. 5 is a flow chart showing an illustrative video analysis algorithm in accordance with an exemplary embodiment of the present invention;

FIG. 6 is a flow chart showing an illustrative closing algorithm in accordance with an exemplary embodiment of the present invention;

FIG. 7 is a diagram showing the operation of the action dispatcher unit of FIG. 2 in greater detail; and

FIG. 8 is a block diagram showing the video image-processing appliance manager of FIG. 2 equipped with a manager harness.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of algorithms and processes are illustrated for the various elements, those skilled in the art will recognize that many of the examples provided have suitable alternatives that may be utilized.

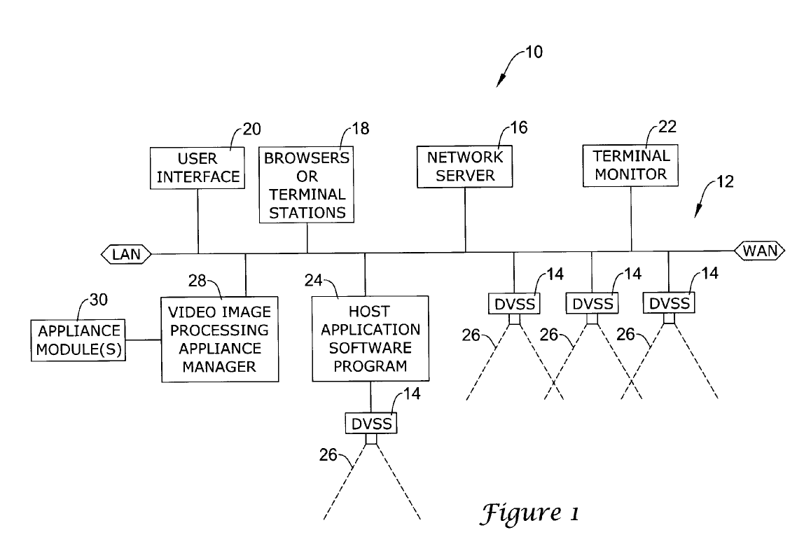

FIG. 1 is a block diagram showing an illustrative network-based video monitoring system 1 0 employing a number of digital video system sensors (DVSS's). System 10, illustratively a video surveillance system for use in detecting and monitoring objects within an environment, may comprise a network 12 such as a wired or wireless local area network (LAN) or wide area network (WAN) that can be used to connect one or more DVSS's 14 to a network server 16 or other such host application. A DVSS can be understood generally as a subsystem that provides sequences of digital video images or other desired data to the monitoring system 10. Examples of DVSS's that can be employed by the system 10 may include, but are not limited to, one or more digital cameras, analog cameras equipped with a digitizer, frame grabbers, digital video recorders, files of stored video data in a database, microphones for audio signal capture, accelerometers for seismic data capture, pressure sensors, temperature sensors, level and/or flow sensors, proximity sensors, contact sensors (e.g. window or door switches), and/or multi-spectral sensors.

A number of browsers or terminal stations 18 equipped with a user interface 20 (e.g. a graphical user interface) can be connected to the network 12 and tasked to control the operation of the DVSS's 14 in a particular manner. In some embodiments, a terminal monitor 22 (e.g. a closed-circuit television monitor) can also be provided in addition to, or in lieu of, the browsers or terminal stations 18 to view images acquired from one or more of the DVSS's 14. The browsers or terminal stations 18 can be configured to interact with a host application software program 24 that can be used to task the DVSS's 14 in a particular manner. Based on user input via the user interface 20, for example, the host application software program 24 can be used to change operational parameters of the DVSS's 14 (e.g. PTZ settings, ROI settings, resolution, frame rate, etc.), and/or to task a video image processing appliance manager 28 to perform certain user-defined tasks such as motion detection, motion tracking, etc. If, for example, the user desires to increase the resolution of images received by one or more of the DVSS's 14 in order to perform facial recognition of an individual within a region of interest, the host application software program 24 can be configured to accept a command causing one of the DVSS's 14 to zoom-in on the subject's face and increase the image capture rate. In the illustrative embodiment of FIG. 1, three DVSS's 14 are shown connected to the network 12, each of which can be tasked to acquire video and/or still images within a respective field of view (FOV) represented generally by dashed lines 26. It should be understood, however, that a greater or lesser number of DVSS's 14 may be employed, if desired. As shown in FIG. 1, the DVSS's 14 can be connected to the network 12 directly, through the host application software program 24, or both, as desired.

As can be further seen in FIG. 1, the host application software program 24 can be configured to call a video image-processing appliance manager 28 that can be used to facilitate processing of video images received from the DVSS's 14 using a number of plug-in appliance modules 30. The appliance manager 28 can be adapted to interface with the host application software program 24 as well as other components within the system 10. The video images and/or other information acquired by the DVSS's 14 can be fed through the appliance manager 28, which tasks the appropriate appliance modules 30 to determine the occurrence of any events configured within the system 10. If an event is triggered, the appliance manager 28 can be configured to output a response (e.g. via the user interface 20) indicating that an event has occurred within a region of interest. If desired, the video images triggering the event can be stored on a hard-drive, magnetic tape, or other storage medium, allowing the video images to be replayed and/or subsequently processed. In some embodiments, the video images acquired from the DVSS 14 can also be displayed in real-time on the terminal monitor 22.

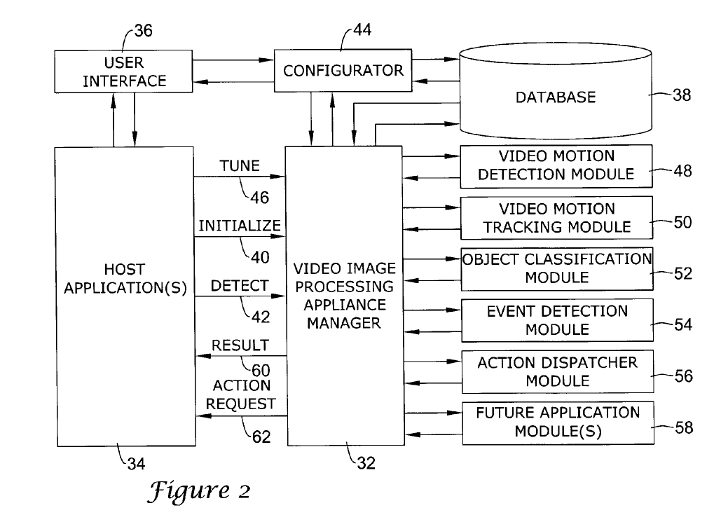

FIG. 2 is a block diagram showing the architecture of a video image-processing appliance manager 32 in accordance with an exemplary embodiment of the present invention. As shown in FIG. 2, the appliance manager 32 may provide an interface to a number of host applications 34, which as is described above with respect to FIG. 1, can include various software algorithms and/or functionality for operating a number of DVSS components. The host applications 34 may include, for example, an existing host application software program configured to interact with one or more video cameras (e.g. DVSS's) each adapted to acquire video images within a field of view (FOV). The appliance manager 32 can also be interfaced with other types of DVSS's including, but not limited to, frame grabbers, digital video recorders, files of stored video data in a database, microphones for audio signal capture, accelerometers for seismic data capture, pressure sensors, temperature sensors, level and/or flow sensors, proximity sensors, contact sensors (e.g. window or door switches), and/or multi-spectral sensors, as desired.

The host applications 34 can comprise separate components from the DVSS's (e.g. a stand-alone software package), or can be formed integral with one or more of the DVSS's and provided as a single component, if desired. In certain embodiments, for example, one or more of the DVSS's may comprise a physically separate video camera that is connected to an existing software-based host application adapted to run on the Internet, an intranet connection, and/or on an individual workstation equipped with a user interface 36. In such applications, each of the associated DVSS's can be connected to their associated host application 34 using an application program interface (API) or other suitable interface.

The host applications 34 may comprise one or more existing host application software programs contained on a network server, browser, terminal station, or other platform. The functionality provided by the existing host applications 34 will typically vary depending on their intended use. If, for example, the host applications 34 are adapted to interface with network-based control, access, and security systems/products, the host applications 34 may include an existing security software program that can be used to task a number of DVSS's to pan, tilt, and zoom to a tracked motion within a region of interest. Examples of other types of host applications 34 may include, but are not limited to, building management applications (e.g. HVAC control), life safety applications (e.g. fire protection, medical care, etc.), asset location applications, and energy management applications.

The appliance manager 32 will typically comprise a separate module from the host applications 34, allowing the appliance manager 32 to be linked with the user's existing system without having to significantly modify or reprogram the existing software to accommodate new DVSS clients as they are added to the system. It should be understood, however, that the appliance manager 32 and host applications 34 could be incorporated together as a single, stand-alone module, if desired.

The appliance manager 32 can be configured to maintain one or more business objects, which can include various information about the region or regions of interest to be monitored, any events configured by a configurator 44, as well as various configuration information about the host applications 34 connected to the system. In certain embodiments, for example, the appliance manager 32 can be configured to maintain a camera structure list and an event structure list containing information about the type of DVSS's employed and the type of events configured within the system. Such lists can be stored within a memory unit or database (e.g. database 38) and recalled each time the appliance manager 32 receives an initialization call 40 or detection call 42 from one or more of the host applications 34.

The video monitoring system may include a configurator 44 that can be used in the direct manipulation and configuration of images or other data received by the host applications 34. A tuning request/call 46 received from one or more of the host applications 34 can be used by the configurator 44 to tune the appliance manager 32 and/or other desired system components to function in a particular manner. If, for example, a user desires to increase the frame capture rate of one of the DVSS's (e.g. a video camera) field of view, the host application 34 can be configured to send a tuning request or call 46 to the appliance manager 32 that can be used by the configurator 44 to coordinate such a change. Once the change has been made, the appliance manager 32 can then be configured to pass the newly configured video stream through. In some embodiments, the configurator 44 can also be configured to send a response to the host application 34 and/or to the user indicating whether the tuning invocation succeeded or failed.

The appliance manager 32 can be connected to a database 38 that can be configured to store information received from the DVSS's as well as parameters received by the configurator 44, as directed by the appliance manager 32 and/or user via the user interface 36. In certain embodiments, the database 38 can be two separate databases residing at different servers, wherein one database can be linked to the host application 34 and the other database can be linked to the appliance manager 32. In other embodiments, the database 38 may comprise a single database, or multiple databases existing on a single server.

The appliance manager 32 can be configured to interact with a number of plug-in appliance modules each adapted to run various video image-processing algorithms or routines that can be used to perform certain user-defined image processing functions. In the illustrative embodiment of FIG. 2, for example, the appliance manager 32 is shown operatively connected to a video motion detection (VMD) module 48, a video motion tracking (VMT) module 50, an object classification (OC) module 52, an event detection module 54, and an action dispatcher module 56. The various appliance modules 48, 50, 52, 54, 56 can be provided as either software appliances adapted to be run on a network or terminal server, or as separate hardware units that can be plugged into the appliance manager vis-a-vis a network bridge or other suitable connection. These modules 48, 50, 52, 54, 56 can be upgraded, when needed, to enhance performance and/or meet specific host application requirements.

The appliance manager 32 can be configured to permit the modular incorporation of future appliance modules 58, as desired. If, for example, the user desires to add a facial detection module or rapid eye detection module to the video monitoring system, the appliance manager 32 can be configured to accept a software call, network socket, physical port (e.g. a USB port, Firewire/IEEE 1394 port, parallel/serial port, etc.), and/or wireless port that can be used to add the additional modules. Since an appliance manager 32 is provided to interface with the host applications 34, the addition of future plug-in modules does not require the user to re-code or re-formulate the existing host applications 34. In addition, the appliance manager 32 may provide the user with the ability to change the implementation and/or features of existing functionality without significantly affecting the operation of the DVSS's.

The appliance manager 32 can be configured to run a video image-processing algorithm or routine that continuously monitors the camera structure list and configured events list to determine whether an event has been detected by one or more of the DVSS's. When an event contained within the event list is detected, the appliance manager 32 can be configured to transmit a result 60 back to the host application 34 along with an action request 62 tasking one or more of the DVSS's to operate in a particular manner. If, for example, the video motion tracking module 50 detects that an object is moving in a particular direction within a region of interest, the appliance manager 32 can be configured to provide a result 60 to the appropriate host application 34 informing it that the object is being tracked along with an action request 62 tasking one or more associated DVSS's to track the object.

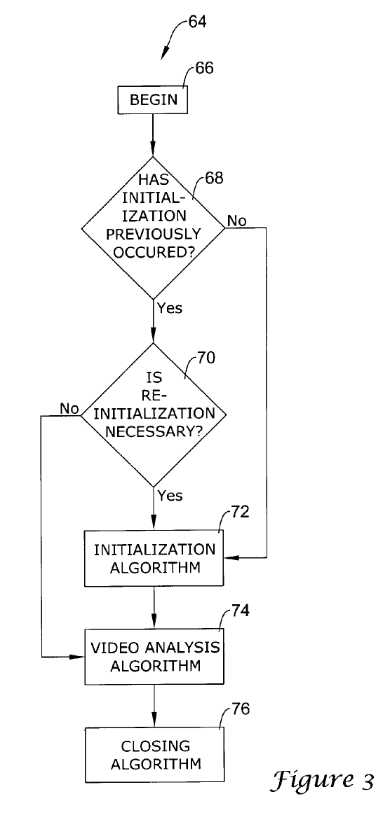

Turning now to FIG. 3, an illustrative video image-processing algorithm 64 for use by the appliance manager 32 of FIG. 2 will now be described. As shown in FIG. 3, video image-processing algorithm 64 may begin at block 66, wherein a call is received by the appliance manager 32 from one or more host applications 34/DVSS clients. Once invoked, the appliance manager 32 determines whether initialization of the video image-processing algorithm 64 has previously occurred, as illustrated generally by decision block 68. If initialization has not previously occurred, the appliance manager 32 may then invoke an initialization algorithm 72 that acquires various parameters relating to the host applications 34 and/or DVSS clients to be used by the system in detecting events. Otherwise, if initialization has previously occurred, the appliance manager 32 may determine whether re-initialization may be necessary, as indicated generally by decision block 70. If, for example, the appliance manager 32 has been previously initialized but a power interruption or loss has occurred, or if one of the DVSS settings (e.g. position) has been changed, then the appliance manager 32 can be configured to go to block 72 and repeat the initialization algorithm, if needed.

Once the initialization algorithm 72 has been initialized (or if re-initialization at decision block 70 is unnecessary or undesired), the appliance manager 32 may next invoke a video analysis algorithm (block 74) that analyzes video images acquired from each host application 34 and/or DVSS 14 used in detecting the configured event. During this step, the appliance manager 32 can be configured to call one or more of the appliance modules 48, 50, 52, 54, as needed, to process the video images and/or other data received from the DVSS's tasked by the monitoring system. If the appliance manager 32 detects the occurrence of the configured event, or if some other user-defined event occurs, the appliance manager 32 can be configured to invoke a closing algorithm (block 76) and output a response to the host application 34 and/or a user. Otherwise, the appliance manager 32 can be configured to repeat the video analysis algorithm step 74 for each frame to be analyzed until an event is detected by one of the DVSS's.

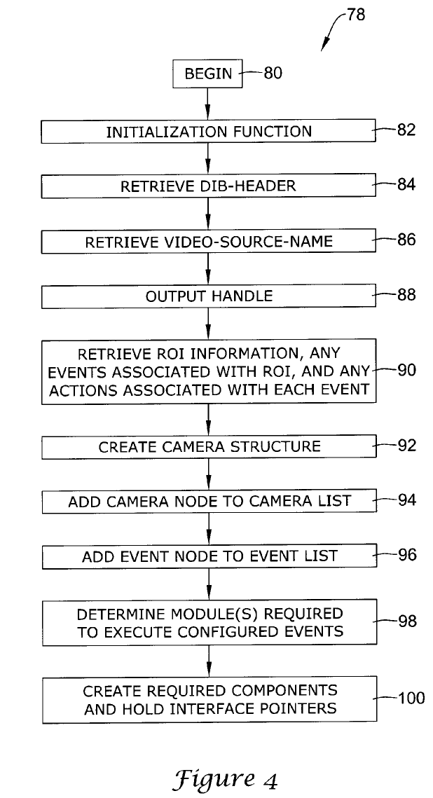

FIG. 4 is a flow chart showing an illustrative initialization algorithm 78 in accordance with an exemplary embodiment of the present invention. As shown in FIG. 4, the initialization algorithm 78 may begin at block 80 by invoking an initiation function 82 within the appliance manager 32 that acquires information about the DVSS's employed by the video monitoring system. The initialization function 82 may be invoked, for example, when a scheduled video motion detection event has begun, or when a user and/or host application 34 has enabled video motion detection in one or more of the DVSS's. Invocation of the initialization function 82 may also occur in certain instances when a user and/or host application 34 has enabled a DVSS that is configured to perform video motion detection, or where the user and/or host application 34 changes the DVSS's resolution settings.

Once the initialization function 82 has been invoked, the appliance manager 32 can be configured to receive a number of parameters relating to the type of images or other such data to be acquired. As shown by reference to block 84, for example, the appliance manager 32 can be configured to retrieve a device independent bitmap (DIB) header that contains image header information relating to the types of images that will be received in subsequent analyzing steps (e.g. during calls for the video analysis algorithm 74 of FIG. 3). If, for example, one or more of the DVSS's are adapted to transmit DIB files that are later used to detect and track motion within a particular region of interest, the DIB header can be configured to contain information (e.g. height, width, aspect ratio, color, resolution, compression, etc.) relating to the type of bitmap images that will be passed to the appliance manager 32. While the use of a DIB-type header is specifically depicted in the illustrative algorithm 78 of FIG. 4, it should be understood that the header can be configured for use with other image types such as TIFF's, JPEG's, MJPEG's, MPEG's, etc. Moreover, because the appliance manager 32 can be easily upgraded to accommodate new file formats as they become available, future image file types can be handled by the appliance manager 32, as desired.

As can be seen by reference to block 86 in FIG. 4, the appliance manager 32 can also be configured to receive a video source name input parameter containing the name of the DVSS within the system corresponding to the DIB header. The video source name input parameter may identify those algorithm settings, ROI's, etc. that are to be used by the video monitoring system. In certain embodiments, the video source name input parameter may comprise a preset name (e.g. “PTZ Video Camera 1”) in those cases where live images are acquired. In other embodiments, the video source name input parameter may comprise a user-defined name (e.g. “Operator Name”) in those cases where previously recorded images are used for video searching.

Once the DIB header 84 and video source name input parameters 86 are defined, the appliance manager 32 can then be configured to output a unique handle (block 88) that can later be used to identify a particular instance of video processing applicable to a particular video source. From this information, the appliance manager 32 may then set-up a number of internal variables and/or structures, which can later be recalled when the video analysis algorithm 74 is called by the handle.

Once a unique handle is created, the appliance manager 32 can be configured to analyze the ROI information from each DVSS to be tasked, any events associated with the ROI, and any actions associated with each event, as shown generally by reference to block 90. If there are any events configured within the event structure list, the appliance manager 32 considers processing that ROI, otherwise it ignores the processing of that ROI. With respect to each DVSS within the system, the appliance manager 32 may consider processing by the DVSS only if there is at least one ROI to be considered, thereby saving processing resources only for those DVSS's to be tasked to perform a particular function.

Once the appliance manager 32 has the requisite information about the ROI, it may then create a camera structure database and add the appropriate ROI information to that database, as shown generally by reference to block 92. After populating the camera structure database with information about each ROI, the appliance manager 32 may then add a camera node to a camera list, as show generally by reference to block 94. The camera list may comprise a list of those global variables pertaining to each DVSS tasked to process at least one ROI. The appliance manager 32 can also be configured to retrieve information pertaining to events associated to the DVSS, and then store the configured events as an event node, as shown generally by reference to block 96. After successfully creating an event node, the appliance manager 32 can then be configured to store the node in an event list, which similar to the camera list, contains global variables relating to those event configured within the system.

Once the events are retrieved and stored, the appliance manager 32 can be configured to scan the events within the event list and determine which appliance module(s) are required to execute the configured events, as shown generally by reference to block 98. If, for example, a DVSS within the video monitoring system is configured to classify a moving object as either a human actor or a vehicle, the appliance manager 32 can be configured to call the object classification module 52 to process images received from that DVSS. The appliance manager 32 can be configured to task each DVSS within the system beginning with a first DVSS client and following with each successive DVSS client until all DVSS clients adapted to run the configured event have been identified and provided with a unique identifier. The appliance manager 32 may then create the required components and interface pointers necessary to execute the configured events, as shown generally by reference to block 100.

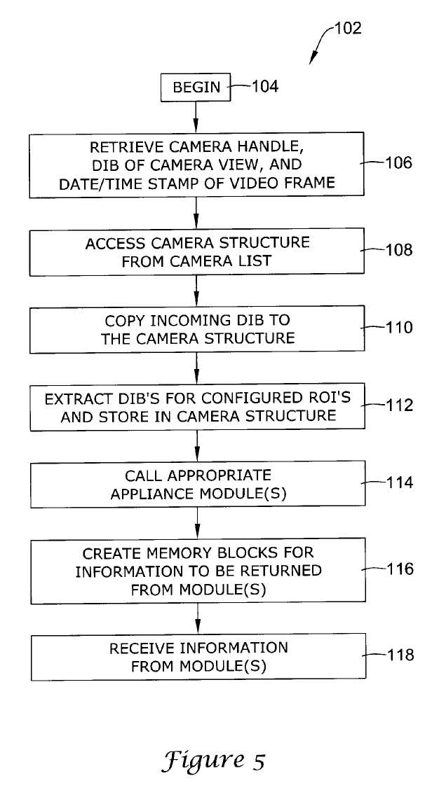

Referring back to FIG. 3, once a unique identifier has been assigned to each newly configured DVSS client within the system, the appliance manager 32 can then be configured to analyze data acquired from the DVSS's in order to detect the occurrence of one or more configured events. In one embodiment depicted in FIG. 5, for example, an illustrative video analysis algorithm 102 may begin at block 104 with the receipt of the output handle of each configured client, the DIB or bitmap of the client's field of view, and the date/timestamp of the particular video frame acquired (block 106). Once received, the appliance manager 32 can then be configured to access the particular camera structure from the camera list stored within the database 38, as shown generally by reference to block 108. The incoming DIB can then be copied to the camera structure, as shown generally by reference to block 110, allowing the appliance manager 32 to extract and store those DIB's corresponding to the configured ROI's within the camera structure (block 112).

For each ROI DIB extracted, the appliance manager 32 can then be configured to call the appropriate module or modules to process images received from the configured DVSS clients, as shown generally by reference to block 114. If, for example, the appliance manager 32 is to be tasked to detect object motion within a ROI, the appliance manager 32 can be configured to call an algorithm or routine within the video motion detection module 48 while passing the ROI DIB to that module 48. The video motion detection module 48 can then be configured to output parameters (e.g. minimum boundary rectangle (MBR) coordinates, patch, features, etc.) for each moving object detected, which are then consolidated and stored within memory.

In certain embodiments, the video motion detection module 48 can be configured to detect motion using a color and edge-based algorithm, which involves the generation of mean and variance images based on the color and edge information of each of the frames within a video sequence. A first level of processing may utilize color information in order to extract motion regions within the DVSS's field of view as a first cue to extract motion regions from a frame. To account for the shape and contour of the moving object, a second level of processing may utilize various edge information contained within each of the image frames. The resultant model is then thresholded using standard deviation information to conclude whether a particular pixel within the field of view belongs to the foreground or background, leading to the formation of both a color and edge foreground confidence map. The final, motion-segmented result can then be obtained by collating the information obtained from both the color and edge foreground confidence maps. While the fusion of color and edge-based algorithms can be used to detect motion of an object within a ROI, it should be understood that other methods and techniques can be employed.

After tasking the video motion detection module 48 and receiving parameters relating to each moving object, the appliance manager 32 can then be configured to provide this information to the video motion tracking module 50. If the video motion tracking module 50 determines that the object is a moving target, the module 50 can then be configured to output a number of parameters (e.g. Object ID's associated to MBR, direction, speed, future state, etc.). From this information, the appliance manager 32 can then create memory blocks for the object structures and then populate the memory with information returned by video motion detection and video motion tracking modules 48, 50, as shown generally by reference to blocks 116 and 118.

Once the memory is populated with information from the video motion detection and tracking modules 48, 50, the appliance manager 32 can next determine whether to call the object classification module 52 in order to compute the behavior of a tracked object within a ROI. If so, the appliance manager 32 may then call the object classification module 52, causing that module 52 to process information received from one or more of the DVSS clients and output a number of parameters relating to the identity of a tracked object. If, for example, the object classification module 52 is configured to determine whether an object is an individual, the module 52 can be configured to output a number of parameters (e.g. height, gender, etc.) relating to the individual. After receiving this information, the appliance manager 32 can then repeat the steps at blocks 116 and 118 to create memory blocks for each classified object and then populate the object variables with information received from the object classification module 52. If desired, a sequential classification algorithm or routine may be employed to provide a more consistent output from the object classification module 52.

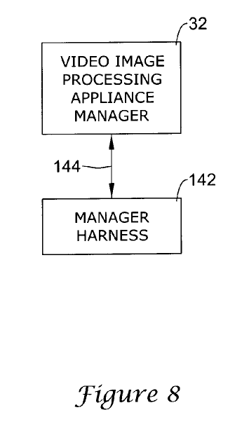

The video analysis algorithm 102 may be performed using live video feeds from the DVSS clients, or using a previously recorded video clip using, for example, a manager harness, as described below with respect to FIG. 8. In the former case, for example, the video analysis algorithm 102 can be used to facilitate automated processing of real-time video to permit the detection of events configured within the event detection module 54. In the latter case, the video analysis algorithm 102 can be used in video searching (i.e. post-processing) applications to search through previous recorded video clips to detect the occurrence of an event. If, for example, the user desires to search through a series of video clips to detect the occurrence of an event or events, the user may invoke the video analysis algorithm 102 to query one or more events contained within the event detection module 54. Examples of such queried events may include, but are not limited to, the counting of individuals passing into or out of an area, the detection of license plate numbers on a vehicle, the detection of individuals or vehicles moving in a particular direction or path, the detection of an individual crossing a virtual tripwire, the detection of an individual in a secure location, etc.

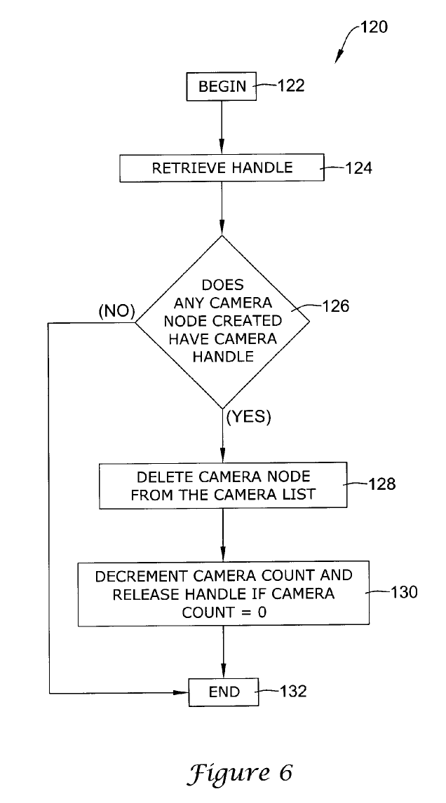

Once the appliance manager 32 has received the desired information from various appliance modules 48, 50, 52, 54, the appliance manager 32 can then be configured to close the video analysis algorithm 102 and invoke a closing algorithm, as indicated, for example, by reference to block 76 in FIG. 3. In one embodiment depicted in FIG. 6, for example, an illustrative closing algorithm 120 may begin at block 122, wherein the appliance manager 32 invokes the algorithm 120 and retrieves the handle relating to those DVSS clients that were tasked during the prior video analysis algorithm 74. Invocation of the closing algorithm 120 may occur, for example, when a scheduled video motion detection event terminates, or when a user and/or host application disables a DVSS client or function (e.g. video motion detection).

Once the camera handle is received at block 124, the appliance manager 32 next determines whether any camera node within the system corresponds to the camera handle, as indicated generally by reference to decision block 126. If no corresponding camera node is found, the appliance manager 32 may end the algorithm 120 (block 132). If, however, there is a corresponding camera node, the appliance manager 32 can be configured to delete that node from the camera list, as shown generally by reference to block 128. The appliance manager 32 can then be configured to decrease the camera count and release the handle if the camera count is zero, as indicated generally by reference to block 130. Once released, the appliance manager 32 may then end the algorithm 120, as shown generally by reference to block 132. The appliance manager 32 can then be configured to release any memory allocated for the image processing, and/or release the interface pointers of other appliance modules employed, if any.

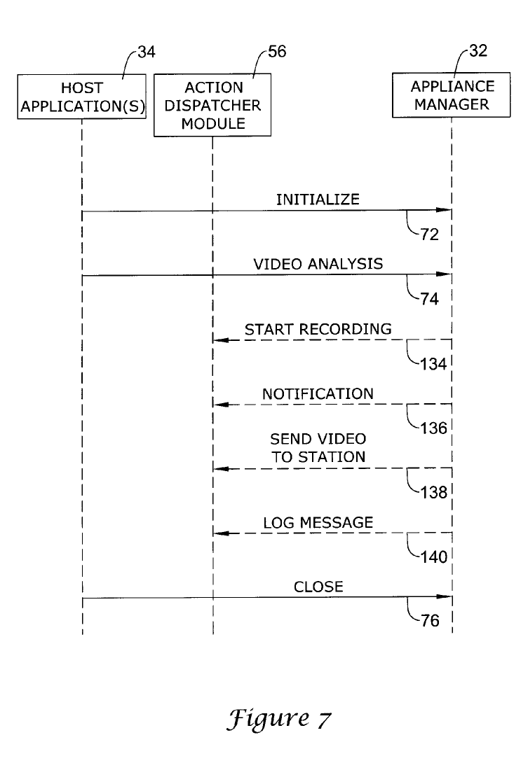

Referring now to FIG. 7, the action dispatcher module 56 of FIG. 2 will now be described in greater detail. As shown in FIG. 7, after the host application 34 has invoked the initiation and video analysis algorithms 72, 74, the appliance manager 32 may, in turn, invoke the action dispatcher module 56 to communicate with the other components within the video monitoring system. If an event is detected by one or more of the DVSS clients, the appliance manager 32 can be configured to initiate a start recording routine 134 within the action dispatcher module 56 that records video images received via the host applications 34. In certain embodiments, the action dispatcher module 56 can be configured to receive the name of the DVSS (e.g. “Video Camera 2”), an event condition indicating that an event has occurred, a description of the event detected, the time required for recording (e.g. 2 seconds, 10 seconds, 5 minutes, etc.), a record frame rate (e.g. 25 frames, 1 every 2 seconds, etc.), the amount of prerecord to be associated with the event recording (e.g. 30 seconds), and/or the time to maintain the recording before deletion (e.g. “keep forever”, “keep for 1 hour”, “keep for 1 month”, etc.). If desired, the start recording routine 134 can also be configured to stop when the event is no longer detected, or when some other event has been detected.

A notification routine 136 invoked within the action dispatcher module 56 can be configured to send an alarm or other response to the user and/or one or more of the host applications 34. If, for example, the monitoring system detects a vehicle entering an entrance during the video analysis algorithm 102 described above with respect to FIG. 5, then the action dispatcher module 56 can be configured to output an alarm or other desired response. If desired, information about the particular client that detected the event as well as a description of the event triggered can be provided to the user and/or host application.

A send-to-video-station routine 138 invoked within the action dispatcher module 56 can be configured to send real-time and/or previously recorded images to a particular operator station, or to multiple operator stations belonging to a particular area. During such routine 138, the action dispatcher module 56 can be configured to output the station or area name associated with the triggered event. If, for example, an event is detected by “Video Camera 1” within the video monitoring system, the action dispatcher module 56 can be configured to transmit images from that video camera to one or more operator stations tasked to monitor that particular camera. The images can be transmitted upon the detection of an event (e.g. a motion detection event), or at some other desired time period. If desired, the appliance manager 32 can invoke a log message routine 140 within the action dispatcher module 56 that logs any errors and/or event messages as they occur.

FIG. 8 is a block diagram showing the video image-processing appliance manager 32 of FIG. 2 equipped with a manager harness 142 for sending one or more different parameter values for evaluation and/or testing purposes, and/or for tasking the appliance manager 32 off-line with previously recorded video. As indicated generally by arrow 144, the manager harness 142 can be called by the appliance manager 32 if one or more parameters to be evaluated differ from that provided by the host application 34. If, for example, a user desires to test the operation of the monitoring system based on a previously stored video clip, the user may invoke the manager harness 142 to test the performance of the system using one or more parameters in addition to, or in lieu of, those provided by the host application 34. If, on the other hand, the caller is a DVSS client, then the appliance manager 32 can be configured to bypass the manager harness 142 and use any default parameters provided by the host application 34. The testing and evaluation of new or modified appliance modules can be further accomplished in a similar manner via the manager harness 142, if desired.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes can be made with respect to various elements described herein without exceeding the scope of the invention.

What is claimed is:

1. A video monitoring system, comprising:
a host application including one or more monitoring devices;
a video image-processing appliance manager called by the host application, said appliance manager configured to run a video image-processing algorithm; and
one or more appliance modules called by the appliance manager.

2. The video monitoring system of claim 1, wherein each of the appliance modules are further adapted to run a video image-processing algorithm therein.

3. The video monitoring system of claim 1, wherein the video image-processing algorithm includes an initiation algorithm.

4. The video monitoring system of claim 1, wherein the video image-processing algorithm includes a video analysis algorithm.

5. The video monitoring system of claim 1, wherein the video image-processing algorithm includes a closing algorithm.

6. The video monitoring system of claim 1, wherein the appliance manager is configured to run, in sequence, an initiation algorithm, a video analyzing algorithm, and a closing algorithm.

7. The video monitoring system of claim 1, wherein the appliance manager comprises a separate module from the host application and forms a single interface for the one or more monitoring devices.

8. The video monitoring system of claim 1, wherein said one or more monitoring devices includes at least one video camera.

9. The video monitoring system of claim 1, wherein said one or more appliance modules includes a video motion detection module.

10. The video monitoring system of claim 1, wherein said one or more appliance modules includes a video motion tracking module.

11. The video monitoring system of claim 1, wherein said one or more appliance modules includes an object classification module.

12. The video monitoring system of claim 1, wherein said one or more appliance modules includes an event detection module.

13. The vide monitoring system of claim 1, wherein said one or more appliance modules includes an action dispatcher module.

14. The video monitoring system of claim 1, wherein said one or more appliance modules are selected from the group of modules consisting of a video detection module, a video motion tracking module, an object classification module, an event detection module, and an action dispatcher module.

15. The video monitoring system of claim 1, further comprising a database in communication with the appliance manager.

16. The vide monitoring system of claim 15, wherein the database includes a camera structure database and an event database.

17. The video monitoring system of claim 1, wherein the appliance manager is adapted to permit modular incorporation of future appliance modules within the video monitoring system.

18. The video monitoring system of claim 1, further comprising means for configuring images or other data transmitted from the host application to the appliance manager.

19. The video surveillance system of claim 1, wherein the appliance manager includes a manager harness.

20. The video monitoring system of claim 1, wherein said host application comprises a host video application software program.

21. The video monitoring system of claim 1, wherein said system comprises a LAN network.

22. The video monitoring system of claim 1, wherein said system comprises a WAN network.

23. A video monitoring system, comprising:
a host application including one or more monitoring devices;
a video image-processing appliance manager called by the host application, said appliance manager configured to run a video image-processing algorithm;
one or more appliance modules called by the appliance manager; and
wherein the appliance manager is adapted to permit modular incorporation of one or more additional appliance modules within the video monitoring system.

24. The video monitoring system of claim 23, wherein the video image-processing algorithm includes an initiation algorithm.

25. The video monitoring system of claim 23, wherein the video image-processing algorithm includes a video analysis algorithm.

26. The video monitoring system of claim 23, wherein the video image-processing algorithm includes a closing algorithm.

27. The video monitoring system of claim 23, wherein the appliance manager comprises a separate module from the host application and forms a single interface for the one or more monitoring devices.

28. The video monitoring system of claim 23, wherein said one or more monitoring devices includes at least one video camera.

29. The video monitoring system of claim 23, wherein said one or more appliance modules includes a video motion detection module.

30. The video monitoring system of claim 23, wherein said one or more appliance modules includes a video motion tracking module.

31. The video monitoring network of claim 23, wherein said one or more appliance modules includes an object classification module.

32. The video monitoring system of claim 23, wherein said one or more appliance modules includes an event detection module.

33. The video monitoring system of claim 23, wherein said one or more appliance modules includes an action dispatcher module.

34. The video monitoring system of claim 23, wherein said one or more appliance modules are selected from the group of modules consisting of a video detection module, a video motion tracking module, an object classification module, an event detection module, and an action dispatcher module.

35. The video monitoring system of claim 23, further comprising a database in communication with the appliance manager.

36. The video monitoring system of claim 35, wherein the database includes a camera structure database and an event database.

37. The video monitoring system of claim 23, further comprising means for configuring images or other data transmitted from the host application to the appliance manager.

38. The video monitoring system of claim 23, wherein the appliance manager includes a manager harness.

39. The video monitoring system of claim 23, wherein said host application comprises a host video application software program.

40. The video monitoring system of claim 23, wherein said system comprises a LAN network.

41. The video monitoring system of claim 23, wherein said system comprises a WAN network.

42. A video monitoring system, comprising:
a host application including one or more video monitors;
a video image-processing appliance manager called by the host application; and
one or more appliance modules called by the appliance manager, each appliance module adapted to run a number of video image-processing algorithms to process images received from the one or more video monitors.

43. A video monitoring system, comprising:
a host application including one or more monitoring devices;
a video image-processing appliance manager called by the host application;
one or more appliance modules called by the appliance manager, each appliance module adapted to run a number of video image-processing algorithms for determining the occurrence of an event within a region of interest; and
a database adapted to store one or more parameters relating to the one or more monitoring devices and/or the one or more appliance modules.

44. A video monitoring system, comprising:
a host application including one or more monitoring devices;
a video image-processing appliance manager called by the host application; and
one or more appliance modules each adapted to run a number of video image-processing algorithms, said one or more appliance modules being selected from the group of modules consisting of a video detection module, a video motion tracking module, an object classification module, an event detection module, and an action dispatcher module.

45. A method of interfacing with one or more monitoring devices within a video monitoring network, comprising the steps of:
providing a video image-processing appliance manager adapted to provide an interface with a host application including one or more monitoring devices;
associating the appliance manager with one or more appliance modules each adapted to run a number of video image-processing algorithms or routines;
analyzing video images received from at least one of the monitoring devices using one or more of the appliance modules; and
outputting a response to the host application and/or a user.

46. The method of claim 45, wherein said step of analyzing video images received from at least one of the monitoring devices includes the steps of:
calling an initiation algorithm within the appliance manager and creating a camera structure database and an event database; and
calling a video analysis algorithm within the appliance manager and tasking one or more of the appliance modules to detect the occurrence of an event within a region of interest.
